(19) United States
(12) Patent Application Publication
(10) Pub. No.: US 2008/0128498 A1
(43) Pub. Date: Jun. 5, 2008

(54) SYSTEM, METHOD, AND APPARATUS FOR HIGH VALUE PRODUCT MANAGEMENT AND TRACKING

(76) Inventors: Andrew T. Fausak, Coppell, TX (US); Lawrence J. Quinnell, Discovery Bay, CA (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 11/567,207

(22) Filed: Dec. 5, 2006

(51) Int. Cl. G06F 19/00

(52) U.S. Cl. 235/385

(57) ABSTRACT

Systems, methods, and computer program products for managing product inventory, and particularly for managing inventories.

The is application claims the benefit of a provisional patent application filed on or about Dec. 5, 2006 by Andrew Fausak and Dale Danilewitz and titled “System, Method, and Apparatus For Pharmaceutical Management and Tracking,” which is incorporated herein for all purposes.

### TECHNICAL FIELD OF THE INVENTION

The present invention is directed, in general, to inventory management and tracking systems, and in particular to high value product management and tracking.

### BACKGROUND OF THE INVENTION

Product tracking is of importance to any manufacturing, wholesale, distribution, consignment, or sales enterprise. It can be particularly important in the high value products area, where many products must be carefully identified and tracked from manufacture until either sold or further consigned. Typical known means of tracking high value products involve manual record keeping and identifying products according to written labels, or utilizing bar code scans. Inventory management and distribution also typically rely on a manual process of taking a physical inventory of product and manually ordering refills or restocking, while also eliminating product that is nearing or passed its expiry, or has outlived the useful sales life (examples include obsolescence, trends, fashion).

Another significant issue with high value products is the very high cost of maintaining an inventory of expensive products. Some products can cost several thousand dollars each, and be relatively rarely purchased or further consigned, but these same high cost goods, when available for an impulse purchase, are needed immediately so as to capture that sales opportunity. Pre-purchasing and stocking such high cost product is a great expense for wholesalers, distributors, and retailers.

### SUMMARY OF THE INVENTION

The present invention relates to improved systems, methods, and apparatuses for managing product inventory, and particularly for managing high value product inventories, which overcome one or more problems with the prior art.

### BRIEF DESCRIPTION OF THE DRAWINGS

For a more complete understanding of the present invention, and the advantages thereof, reference is now made to the following descriptions of exemplary embodiments of the invention, taken in conjunction with the accompanying drawings, wherein like numbers designate like objects, and in which:

FIG. 1 is a simplified block diagram schematically depicting certain elements of a consignment cabinet;

FIG. 2 illustrates a product unit;

FIG. 3 illustrates a front view elevational view of a consignment cabinet;

FIG. 4 is a cross section of FIG. 3, taken along section line 4-4.

FIG. 5 is schematic illustration of certain components of another example of a consignment cabinet.

### DETAILED DESCRIPTION OF THE INVENTION

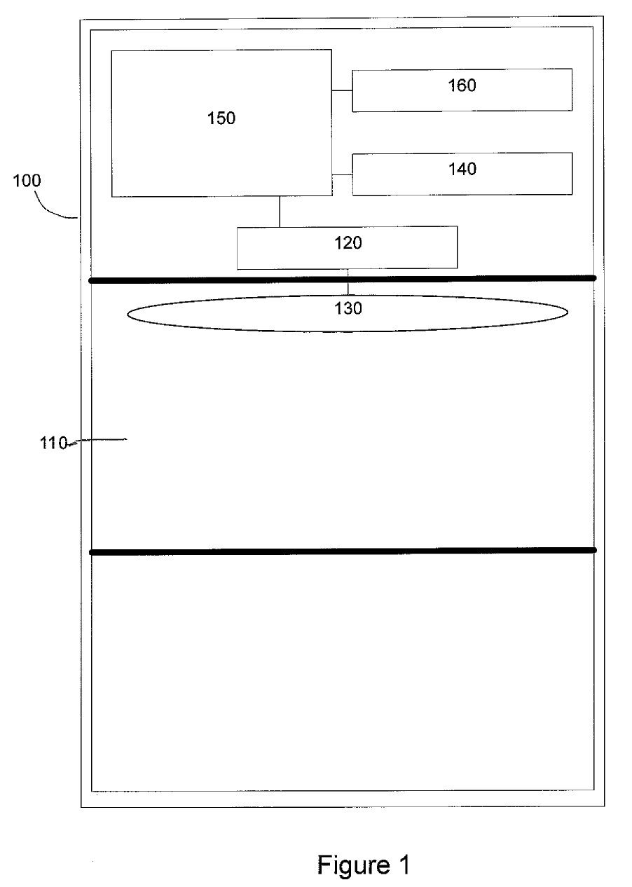

FIGS. 1-5, which depict exemplary embodiments of the present invention, are by way of illustration only and are for purposes of describing the principles of the present invention and a best mode of operation. The invention is not limited to the details of these embodiments.

One embodiment of the present invention is drawn to a system and method for managing high value product inventories, and in particular to managing consigned high value product in third-party facilities, such as jewelry stores, gun shops, and fashion stores. Preferred embodiments include a product-management cabinet capable of tracking product inventory and corresponding products.

With reference to FIG. 1 consignment cabinet 100, in a preferred embodiment, includes a chassis 1 10. The interior of the cabinet, where products are stored, may, optionally, be climate controlled. For example, one example of an implementation of the chassis includes a conventional refrigerator unit modified as described herein to function as the cabinet for goods requiring refrigeration. For ambient-temperature use, a non-refrigerated cabinet can be used, or the refrigeration unit can be turned off, set to the desired temperature, or disconnected.

The cabinet 100 also includes a reader 120 to wirelessly and automatically detect and identify the contents of the cabinet. Preferably, this is a radio-frequency identification (RFID) reader. The cabinet 100 includes one or more RFID antennas 130 connected to RFID reader 120 to scan the contents of the cabinet.

Preferably, the cabinet 100 also includes one or more optional sensor devices 140, such as a door-open sensor and a power-failure sensor and optional backup power supply.

The cabinet also includes a data processing system 150 capable of communicating with and controlling the RFID reader 120. The cabinet data processing system 150 also includes communications software for communicating as described more fully below. The cabinet data processing system 150 is also preferably connected to communicate with and control the optional sensor devices 140 described above.

Cabinet data processing system 150 can be implemented using any appropriate technology and components, capable of operating as described herein, now known or developed later. The cabinet data processing system 150 generally includes at least a processor or controller and an accessible memory for storing data as described herein.

Cabinet data processing system 150 is also connected to communicate with other devices using network interface 160 for communicating over wired or wireless communications networks, or combinations of them. Examples of currently available networks include Ethernet, DSL, cable, cellular data and telephone networks, and IEEE 802.11 local and metropolitan wireless networks. Preferably, network interface 160 is capable of communicating using an internetworking protocol, such as the Internet Protocol and its successor protocols. Network interface 160 allows the cabinet data processing system 150 to communicate with the inventory management system, described below, and optionally with other cabinets 100. In embodiments where multiple cabinets 100 communicate with each other, these can be configured to communicate with the inventory management system as a single unit with a combined inventory.

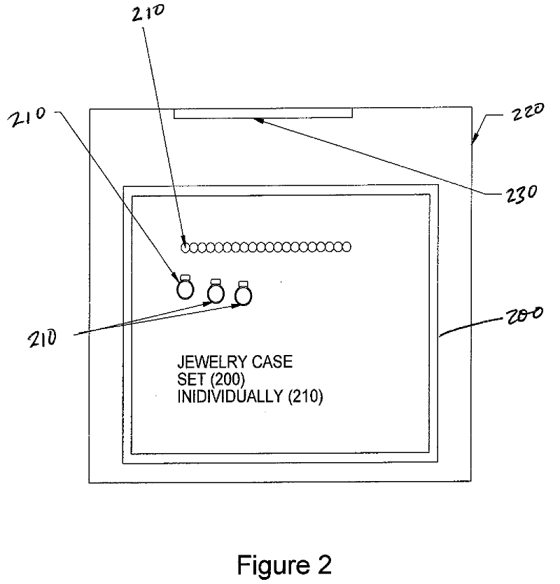

In use, the cabinet data processing system 150 will make periodic inventory scans, using the RFID reader 120, to uniquely identify each product unit 200 (as shown in FIG. 2) stored in the cabinet. If a new identifier is found during any scan, the cabinet data processing system 150 notes the identifier and adds it to a current inventory list for that cabinet. Similarly, if a specific identifier is no longer detected during a periodic scan, because the product has been removed or the RFID tag has been destroyed, the cabinet data processing system 150 notes the missing identifier and removes it from the current inventory list for the cabinet. The identifiers of such removed products are preferably also stored in a “consumed product” list in the cabinet data processing system.

Preferably, cabinet 100 includes a power-failure detection device and a backup power supply. When a power failure is detected, cabinet 100 can sound an audible alarm.

FIG. 2 shows a simple illustration of a product unit 200 as can be used in various embodiments of the present invention. In a preferred embodiment, each product unit 200 includes an RFID tag 230 affixed to the product or its packaging, where the RFID tag 230 includes identifying information capable of being read by the RFID reader.

In a typical implementation, an individual product unit 200 includes the product 210 itself in an appropriate packaging 220, such as a box. The packaging includes the RFID tag 230, which seals the package. The RFID tag has at least a unique identifier, such as a serial number, that can be read by the RFID reader. For ease of reference, the term “serial number” will be used herein to refer to the unique identifier. The numbers need not, however, be serialized. Other types of unique identifier can be used. Preferably, to open the package 220 to use the product 200, the RFID tag 230 is destroyed, at which point it can no longer be read by the RFID reader. However, for businesses in which it is preferably or necessary to recycle the RFID tag, the tag is not destroyed.

The example illustrated in FIG. 2 is intended to represent a generic product. Product 200 is in this example a jewelry case. A product may include multiple items 210. In the Jewelry context, a single piece of jewelry, such as an ear ring can be a single product 210, but multiple ones of these types (for example, matching ear rings, together with a matching necklace) can be packaged together as a single product unit 200, depending on the requirements for use, sale, distribution, dispensing, warehousing, consignment or billing for the product.

The inventory management system performs overall inventory management functions for multiple cabinets 100, as described in more detail below. In general, the inventory management system communicates with cabinets 100 to monitor the inventory of each cabinet 100 on a regular basis. Inventory management system includes a database of the current inventory of each cabinet 100, the product inventory assigned to each cabinet 100, and other information regarding the cabinets 100.

Inventory management system will periodically receive communications from each cabinet 100 including the current inventory list, the consumed product list, and other information. These communications can be initiated by inventory management system, by polling each of the cabinets 100, or can be initiated by the cabinets 100.

This process is particularly useful when the product is not sold when shipped for placement in a cabinet, but rather is held on consignment in the cabinet, and considered sold when removed from the cabinet or the product packaging.

In particular, the embodiments described herein can be used for high-value product, which a retailer may desire to have readily available but not be willing or able to pre-purchase. Consigning a product in the cabinet thus can provide a significant advantage in the wholesale, distribution, and retail industries. Products can be distributed to retailers or others downstream in a distribution chain, and products which have been sold or transferred automatically detected. A consignor can, if desired, automatically initiate payment from the consignee, for example as a draft, or generate an invoice, or use the information to reconcile payments or inventory information from the consignee.

The inventory management system periodically communicates with cabinet 100. Cabinet 100 will detect the serial numbers of the RFID tags of each of the product units, and add those to the current inventory list. Cabinet 100 will communicate the current inventory list to inventory management system, which will update a status record for each corresponding serial number.

When the cabinet 100 no longer detects a given RFID serial number of a product unit 200, that serial number is added to the consumed product list and eventually reported to inventory management system, as described above. Typically, this will be when the product unit 100 is removed and the product is sold, but it can also happen when the RFID tag is destroyed when the packaging is opened, or if the product is otherwise removed, stolen, destroyed, etc.

In a preferred embodiment, a particular product unit is not moved to the consumed product list immediately when it is not detected, but only when it has not been detected for a significant period, such as 24, 48, or 72 hours. This is to accommodate the event that the product unit 200 is removed from cabinet 100 in anticipation of sale or use, but is not actually sold or consumed, and so is returned to the cabinet 100 and is thereafter detected by cabinet 100.

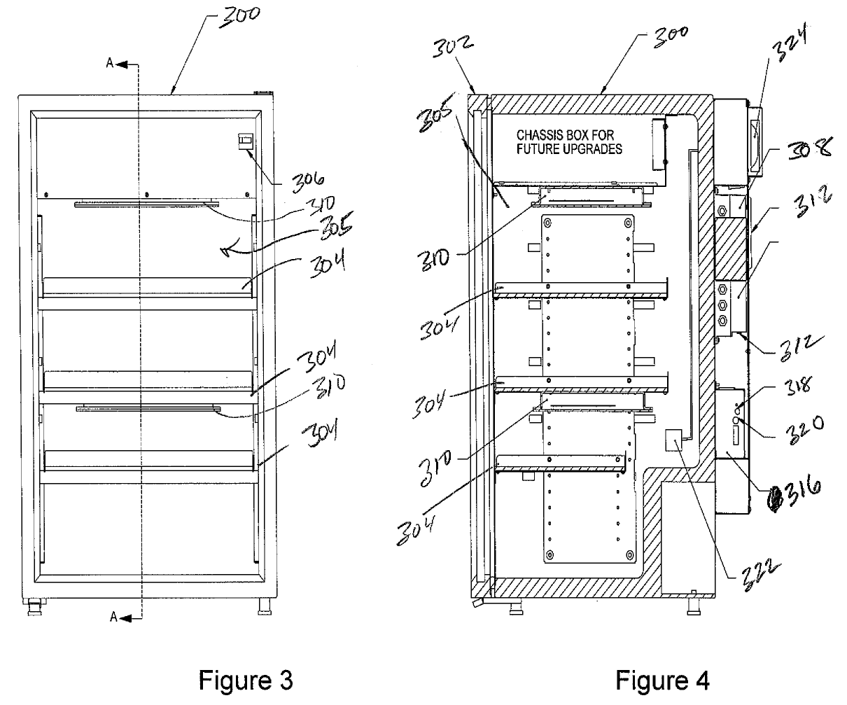

FIGS. 3 and 4 depict an exemplary embodiment of a consignment cabinet 300, which includes representative examples of one ore more features of the invention. In FIG. 3 the door 302 has been removed. It is, nevertheless, shown sectioned in FIG. 4. The cabinet includes several shelves 304 within product storage area 305 on which products may be placed. Door sensor switch 306 detects opening and closing of the cabinet door 302. It communicates with software executing one or more processes associated with operation of the cabinet, and tracking and reporting to a remote inventory management system. In this embodiment, the software is installed on RFID reader 308, which includes an embedded processor and memory. The RFID reader 308 is coupled with RFID antennas 310, which are mounted in product storage area 305 at locations that will read any RFID tags mounted to products stored on the shelves or other areas in which products are expected to be stored. RFID reader 308 includes an network interface 312, including an Ethernet port 314 for communicating over a local Ethernet network, which in turn could be connected to a gateway for communicating to a remote inventory management system. Other electronics include a power distribution and management system 316 and two ports 318 and 320 for reporting data locally for the door sensor 306 and a climate (e.g. temperature and/or humidity) sensor 322. The cabinet is also supplied with a visual and/or audible alarm 324 for alerting those present of a error condition such as unauthorized opening of the cabinet or remove of a product, or a failure of any of the critical components.

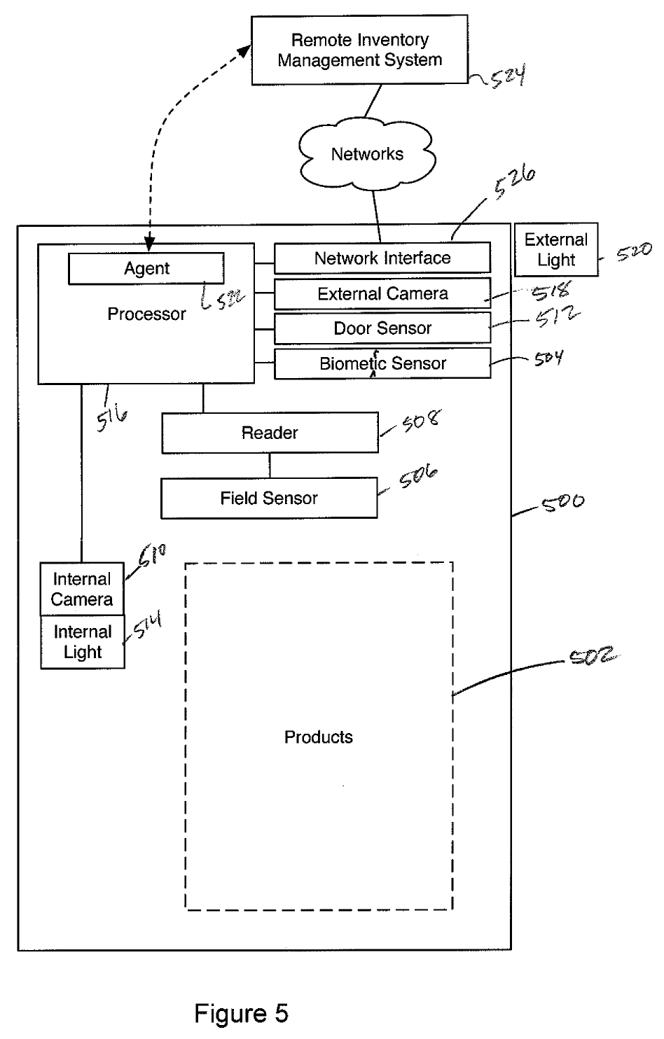

Referring now to FIG. 5, consignment cabinet 500 includes a predefined product storage area 502. Access to the product storage area 502 of the cabinet may, optionally, be controlled using a biometric sensor 504 (e.g. finger print, iris or voice recognition) in addition to other conventional locks and other mechanisms for limiting access. The presence of a product within product storage area 502 is sensed by field sensor 506 and detected by reader 508. Examples of the types of detection mechanism that can be employed include radio frequency, particularly radio frequency identification (RFID), ultrasonic, MRI, capacitance, visual recognition, or combination of these. One or more internal cameras 510, which are optional, capture still or moving images of the product storage area 502. These images may be used for detection and removal of products, confirmation of access to the cabinet reported by door sensor 512, remote auditing of the contents of the product storage area, and other uses, and/or remote monitoring in the event of errors or alarms. The operation of the camera and internal illumination 514 is preferably under control of control processes. In the example shown, these processes run on processor system 516, which includes memory for storing data and program instructions. Processor system 516 also communicates with biometric sensor 504, door sensor 512, external camera 518, external illumination source 520, and reader 508.

The processes executing on the processor operate, for example, by authenticating a person accessing or seeking to access the product storage area 502, detecting opening of the door and turning on illumination, detecting removal of one or more product units from the product storage area 502, and recording or storing information indicating that the items have been removed. The processor optionally captures an image of the person or persons accessing the cabinet using external camera 518, turning on external illumination source 520, as necessary, and optionally also captures an image of the item being removed, or of the product area immediately after removal, when movement of the item is detected or absence of the item is determined. Capturing of images of the product storage area immediately before or at the time access and then after removal of items (detected by the absence of previously present item or by a closing of the door, for example) can be compared if necessary at a later time to confirm which items were removed.

Agent software 522 is used to report inventory and/or inventory changes to a remote inventory management system 524 through a network interface 526.

Software implemented processes are in this example shown being implemented on reader 508, which includes software based detection processes, and processor system 516, which is intended to represent a programmable general purpose computing element. However, the software processors may be distributed to multiple computing hosts within the cabinet or outside the cabinet, or may be combined to run on a single host. Furthermore, rather than executing a processes locally, a processes may be executed remotely, using a remote computing protocol. Remote processing can be used for a process that is unique and specialized or that cannot be anticipated in advance. Processors embedded in elements such as product detection mechanisms or readers may be used as the local host.

A cabinet such as shown in FIGS. 1, 3, 4 or 5 could be adapted for use as a vault or safe for valuables by hardening the cabinet walls and improving the locking mechanism for the door.

While the present invention has been described in the context of a fully functional system, at least portions of the mechanisms are capable of being distributed in the form of instructions contained within a machine usable medium in any of a variety of forms. Unless otherwise expressly stated, the claims should not be construed as being limited to any particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” or “steps for” are followed by a participle.

What is claimed is:

1. Apparatus for storing and tracking high value products, comprising:
a product storage cabinet;
means for detecting products within a predetermined area within the product storage cabinet;
means for detecting products present within the product storage cabinet; and
a communication interface for communicating inventory information for the cabinet to a remote product management system.

2. The apparatus of claim 1, further including means for adding to an inventory listing new products detected within the storage cabinet.

3. The apparatus of claim 1, further including means for tracking time a previously present product identification tag has been absent and changing a status of the product when the product has not been detected within the cabinet for at least a predetermined period of time.

4. The apparatus of claim 1, wherein the means for detecting products includes an RFID reader.

5. A method of distributing high value products, comprising:
installing a inventory cabinet at or near a point of sale on the premises of a third party;
stocking the inventory cabinet with high-value products on consignment, the cabinet including a reader for detecting the presence of products within the cabinet and a data processing system for tracking product inventory and a communications interface for reporting inventory information over a communications network;
receiving over a communications network inventory information indicating that a product consigned to the inventory cabinet has not been detected in the cabinet for at least a predetermined period of time; and
collecting from the third party or its designee payment for the product that has not been detected.
